(19) United States
(12) Patent Application Publication
(10) Pub. No.: US 2006/0012611 A1
(43) Pub. Date: Jan. 19, 2006

(54) Method and apparatus for visualizing the fit of an object in a space

(76) Inventor: Daniel L. Dujmich, Staten Island, NY (US)

Correspondence Address: OSTROLENK FABER GERB & SOFFEN, 1180 AVENUE OF THE AMERICAS, NEW YORK, NY, 100368403, US

(21) Appl. No.: 10/892,589

(22) Filed: Jul. 16, 2004

(51) Int. Cl. G09G 5/00

(52) U.S. Cl. 345/619

(57) ABSTRACT

A method for determining the fit of an object in a space comprising obtaining digital data defining the space, inputting the digital data defining the space into a computer system, inputting at least one dimension defining the space, obtaining digitized data defining an object to be fitted in the space, placing the digitized data defining the object in the digitized space and determining if the object fits in the space.

### BACKGROUND OF THE INVENTION

The present invention relates to a method and apparatus for visualizing the fit and appearance of an object in a space. For example, the present invention may be used to visualize the appearance and location of a piece of furniture in a room to determine whether the furniture will fit within the room and with the other objects in the room, if any.

Computerized systems for determining the fit of one object with respect to another are known. For example, U.S. Pat. No. 6,665,577 to Onyshkevych et al. discloses a system for determining the most appropriate fit and size of a garment on the human body. However, the prior art does not teach or suggest a system whereby a consumer, for example, a purchaser of furniture for a room, can visualize and determine the fit of the furniture in the room prior to purchase of the furniture. For example, the prior art does not teach or suggest a system which allows a person to visualize the fit of an object in a room of the person's residence or workspace, for example, or which allows a person to visualize an object at the point of purchase prior to purchase as it would appear in the purchaser's residence or workspace and determine if a fit can be obtained.

The present invention allows a user to digitize an image of a space, input the digitized data defining the space into a computer system and visualize an object or objects in the digitized space, with the object or existing objects being movable within the space to find a satisfactory fit.

### SUMMARY OF THE INVENTION

The present invention relates to a method and apparatus for visualizing the fit of a digitized version of an object in a digitized space. The digitized space may represent a room or other space in which the user wishes to visualize the object. For example, the space may comprise a space or room in the person's residence or workspace prior to purchase of an object so that the user can visualize the appearance and fit of the object in the space prior to purchase. The user can digitally place the object in the space, display it on a suitable display device to determine if the fit and appearance is satisfactory and if not, move the object or other objects in the space until a satisfactory fit is obtained or a satisfactory fit cannot be obtained.

### BRIEF DESCRIPTION OF THE DRAWING(S)

The invention will now be described in detail in the following detailed description in which:

FIG. 1 shows a flow diagram for the system according to the present invention;

FIG. 1A shows a computer system for implementing the invention;

FIG. 2 shows an image of a space which can be digitized, for example, by a digital camera and input into a computer system according to the invention;

FIG. 2A shows the space with an object being checked for fit within the space;

FIG. 2B shows the space after edge determination software has determined the outlines of the space, according to one embodiment;

FIG. 3 shows a floor plan image obtained from the digital data defining the space of FIGS. 2 and 2A showing the object placed in the space; and

FIG. 4 shows a plan view of one wall of the space showing the object being checked for a fit in the space.

Other objects, features and advantages of the present invention will become apparent from the detailed description which follows:

### DETAILED DESCRIPTION OF THE INVENTION

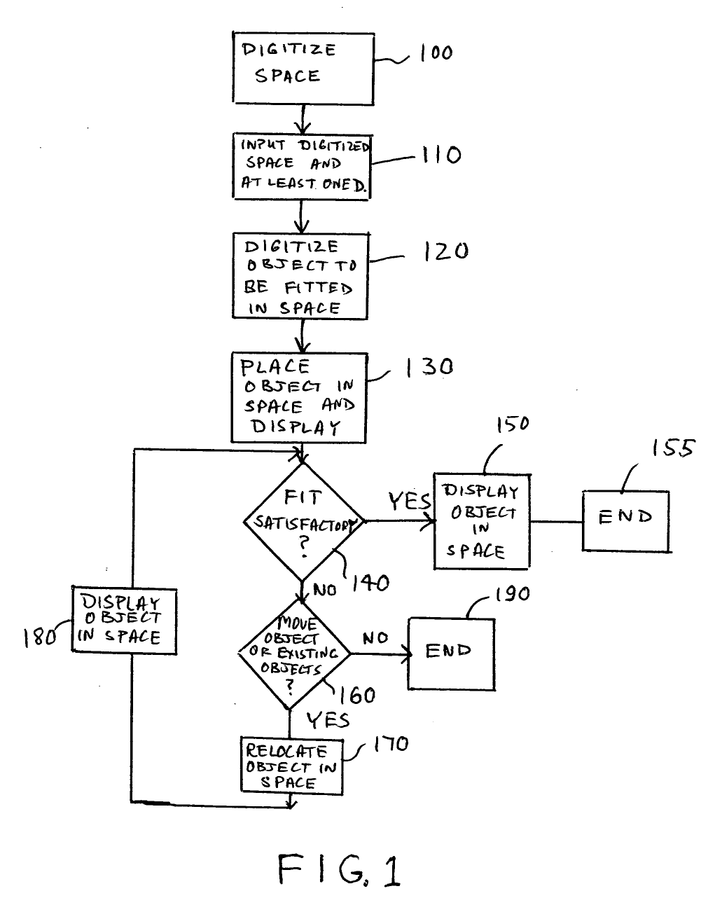

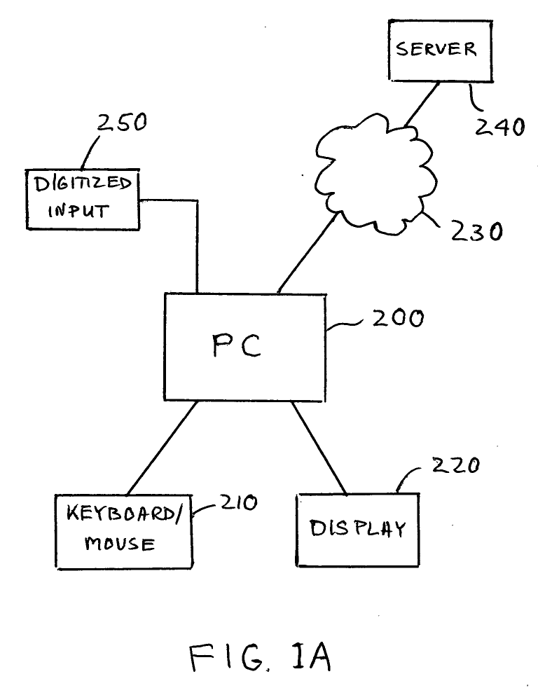

With reference now to the drawings, FIG. 1 shows an example of the system flow for the invention. The invention can be implemented in suitable computer software and can operate on a personal computer, for example. The computer can be located at the user's home or it can be located at a point of purchase for an object whose fit is to be determined, for example, at a retail store selling the objects for which a fit is to be determined. For example, a potential purchaser may want to determine if a piece of furniture or an electrical/electronic appliance, e.g., a washing machine or television, will fit in a space in his residence. Alternatively, a seller of merchandise can offer a service according to the invention over the Internet, so that the user can use the present invention at his personal computer via the Internet.

FIG. 1A shows the hardware of the system. A personal computer 200 including the necessary memory storage space has a program stored in memory, e.g., obtained from a storage medium, such as a magnetic disk or CD ROM, for example. Attached to the PC is a keyboard/mouse/pointer device 210 for entering commands to operate the program and a display 220 for viewing the operation of the program including visualizations of a digitized space and objects in the space. The PC 200 can also be connected to a network 230 such as the Internet. For example, the program according to the invention can be located on a remote server 240, accessed via the Internet, or downloaded from the server 240 via the Internet to PC 200. Digitized input data defining the space and any objects in the space is obtained from an input 250, such as a digital camera or digital scanner. Digital data defining the object to be visualized in the space can be obtained from any suitable digital source, such as a digital camera or scanner or such data may be available from the manufacturer or seller of the object, e.g., from a magnetic disc or CD or other data file. Preferably, it is envisioned that the manufacturer of the object whose fit is to be visualized in the space will be able to supply a digital file defining the object.

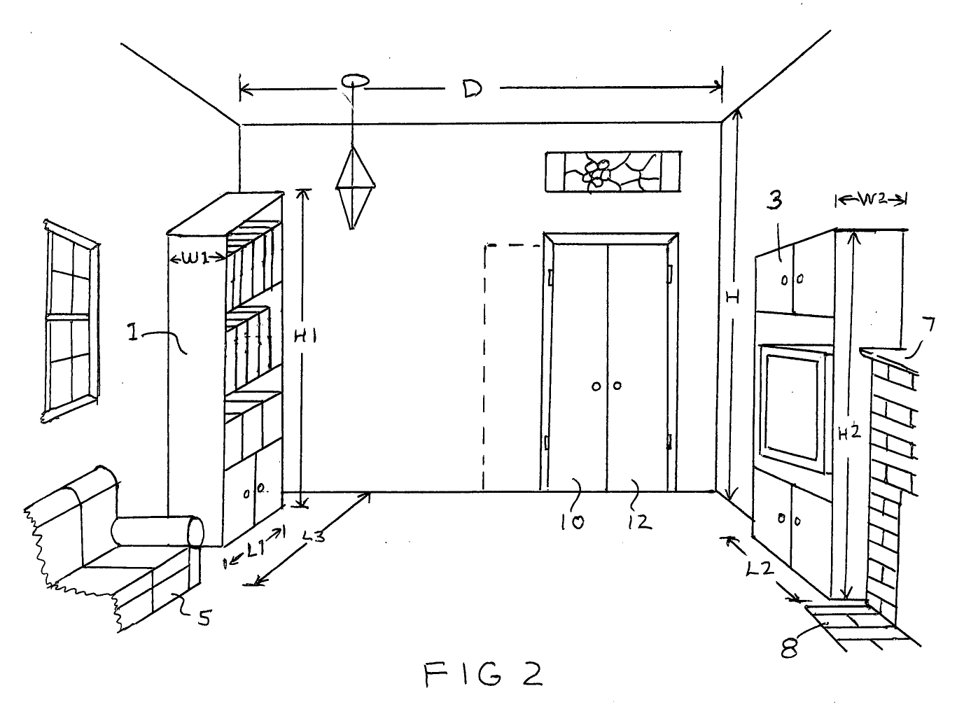

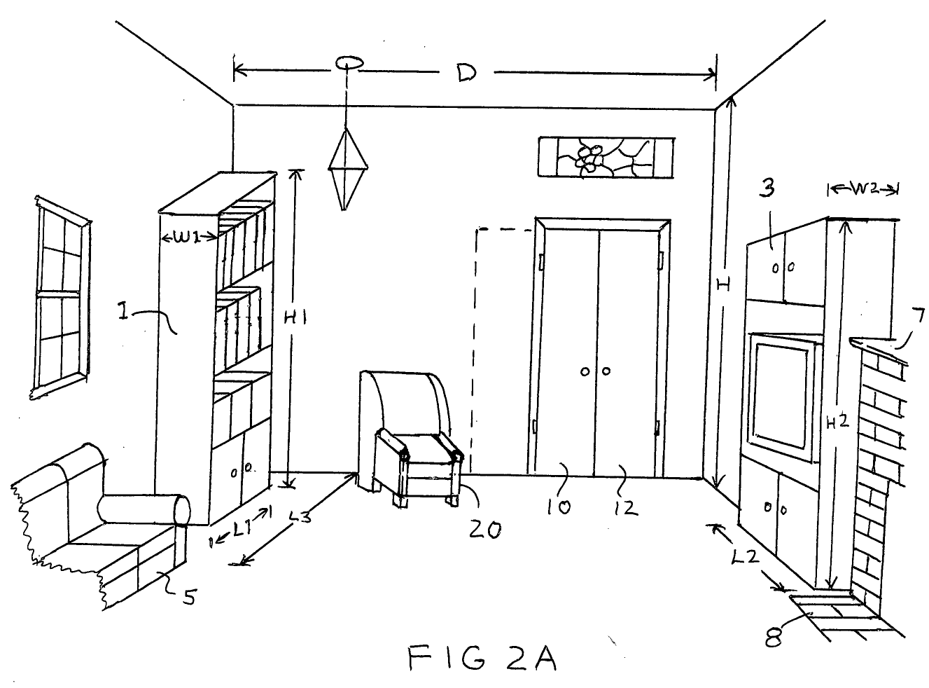

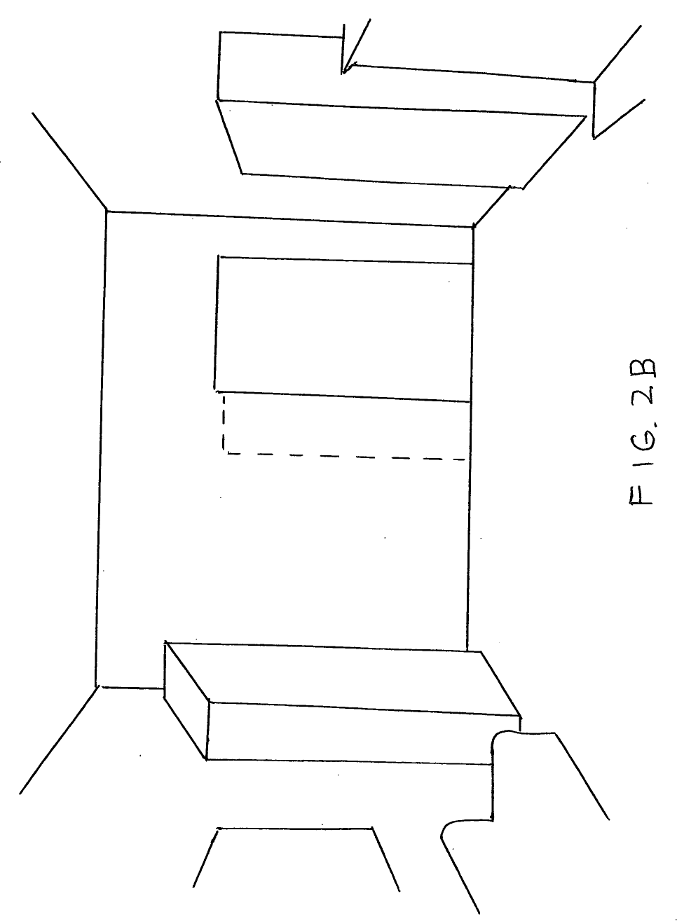

With reference to FIG. 2, this figure shows a space which is to be digitized, for example, a room of a residence. The digitized data defining the space is input into a computer. The image of the space may be digitized using a suitable digital camera or a film camera whose output is scanned and input into the computer system. It may be necessary to employ more than one photograph in order to digitize the space, as required. It may not be necessary to digitize an entire room if the portion of the room where the object is to be checked for fit is sufficiently digitized. For example, in FIG. 2, an object 20 is checked for fit in the area shown in FIG. 2A, so it is not necessary to digitize more than the space shown in FIGS. 2 and 2A.

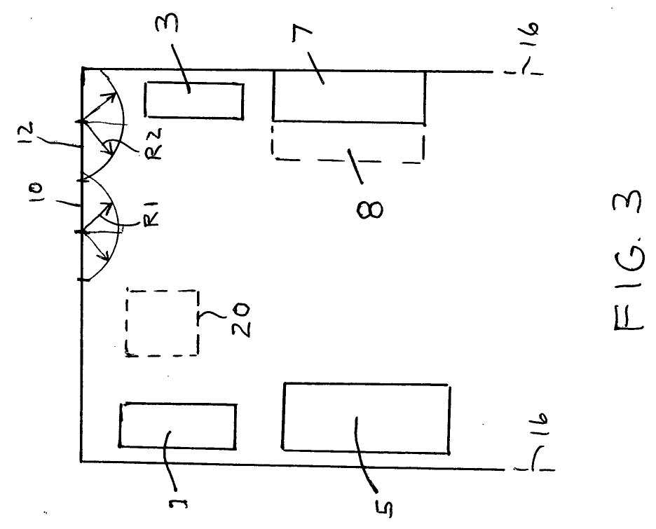

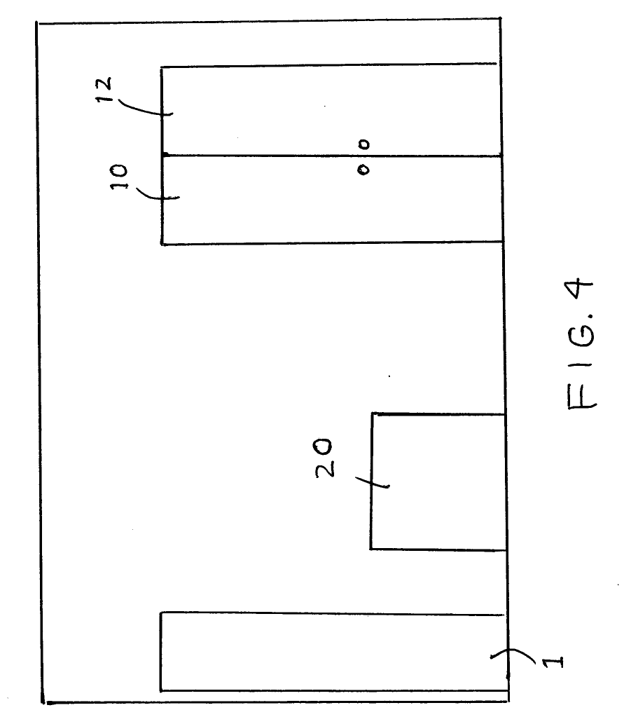

Suitable computer software operating on the computer system may be used to determine the overall dimensions of the space from the digitized data. Software for determining the relative dimensions of a space based on edge location or edge determination is known and may be used to determine the configuration of the space and any existing objects in the space, according to one embodiment, although this is not necessary. For example, FIG. 2B shows how suitable edge location or edge determination software may be used to define the basic outline of the space and any objects in it. At least one dimension, for example, as shown at D in FIG. 2, is input to define at least one dimension of the room. A width dimension D is shown, but any other dimension can be used whereby the computer software can determine all other relevant dimensions based on the spatial relationship and perspective with the defined dimension, for example, based on linear ratios. Based upon the defined dimension, the program determines the other dimensions of the room and of existing objects in the room, for example, the height H of the wall, the height H1, width W1, height H2 and width W2, lengths L1, L2 and L3, etc. of objects in the room. These dimensions can then be used to form a floor plan for the room, as shown in FIG. 3, in digital form, as well as a wall plan, as shown in FIG. 4. Thus, the footprint of the bookcase 1, video display cabinet 3, sofa 5, fireplace 7 and hearth 8 as well as the locations of doors 10 and 12 and can be determined. The system can prompt the user for the location of doors and their pivot axes. In this way, the turning radii of doors can be determined, for example R1 and R2 of the doors 10 and 12. In this way, the system can keep the areas over which the doors pivot clear. In FIG. 1, the digitizing of the space is shown by block 100. The digitized space and at least one dimension D are input into the computer as indicated at 110. As discussed, from the at least one dimension D, the other dimensions of the room or space can be determined.

The digitized space is displayed on the computer screen, preferably in a perspective view as shown in FIG. 2. However, plan images such as a floor plan image as shown in FIG. 3 and a wall plan view as shown in FIG. 4 may also be selected and displayed. The floor plan shown in FIG. 3 is based on the digitized data supplied from the data available in FIG. 2, i.e., from the digitized photograph. Accordingly, the floor plan space displayed is incomplete, as show by the dashed lines 16 in FIG. 3. However, the data is sufficient to enable visualization and fit of the object 26 in the digitized space shown. Additional data, e.g., from another digitized photograph of the front portion of the room would be necessary to digitize the entire space. In such case, the software could use common features, e.g., common objects or edges in the plurality of digitized photographs to “piece” the data together and determine the overall dimensions and layout of the entire room. The software would have to take into account any variations in scale between the plurality of photographs.

An object that is sought to be fit in a room, for example, a piece of furniture that is desired to be purchased, for example, a chair 20 as shown in FIG. 2A, is then placed in the digitized space by the user after the digitized data is entered into the computer. “Click and drag” mouse pointer techniques can be used for this purpose. Analog data representing the object 20 may be digitized, e.g., by a digital camera or digital scanner, and entered into the computer as shown at 120 in FIG. 1. Alternatively, the object may have a predefined data file associated with it, e.g., available from the manufacturer, defining its size, outline and appearance. The object is then placed in the space and displayed at a desired location as shown at 130. If the fit is satisfactory, the object is displayed in the space as shown at 140 and 150 and the program terminates. If the fit of the object is not satisfactory, the user is allowed to move the object or the existing objects to visualize the objects in other locations or with the existing objects moved or both. If the user chooses to move the object or existing objects as indicated at 160, the object is relocated in the space or existing objects are relocated (170) and the object is again displayed in the new position and/or after existing objects are moved around the object. If the fit is satisfactory, the object is displayed in its location and the program ends at 155. If the fit remains unsatisfactory, the object can be moved or existing objects moved again at 160 until a satisfactory location is obtained or the user decides that a satisfactory location cannot be obtained or decides not to move the object or existing objects any longer and the program ends as indicated at 190. The program can also indicate if a satisfactory fit can or cannot be obtained, if desired, or this determination can be left to the user based on noting if there are any collisions between objects from the various views.

Although an embodiment has been discussed wherein edge location software determines outlines of the room, this is not required. Instead, the digital data representing the object can be simply “overlaid” in the space using digital techniques to determine if a fit can be obtained. In such case, the scale of the object and space must be the same or made the same in order to determine if a fit can be obtained.

The present invention thus allows the prospective purchaser, for example, of an object such as furniture, to test the fit of the object in a space or room of his or her residence or workspace, thereby avoiding the situation wherein an object is purchased that will not fit within the existing space. The prospective purchaser can use a photograph such as a film photograph which can be scanned and digitized or a digital medium (e.g., digital camera, disc or memory card) containing a photograph taken with a digital camera which is already in digital form can be used. According to one embodiment, the software analyzes the digitized data representing the space and any objects already in the space using known edge location techniques, determines the outlines of the room and any objects existing in the room, including other furniture, and the locations of doorways and windows, for example. In another embodiment, a digital version of the object is overlaid in the digital space to determine the fit. Although it is envisioned that the user will be prompted for the locations of doors and their pivot axes to determine turning radii, it is also possible to use software capable of recognizing the locations of hinges for doors to determine the door pivoting axis and thus the turning radius so that the turning radius space can be kept clear, as desired. The user also provides at least one dimension defining the space. Based upon this dimension, the other dimensions of the room and of objects in the room can be determined by their relative lengths. Once the space has been digitized, the system of the invention can then insert the object into the space and determine its visual appearance and fit within the space. Any collisions with existing objects in the room will be apparent when visualizing the object in the room such as shown in FIG. 2A or in the floor plan of FIG. 3 or plan view of FIG. 4. The software can identify such collisions to the user by a visual or audible notice or warning.

In addition, the present invention can also be used to visualize the color, texture and appearance of the object in the space. If desired, the system of the invention can also be used to change the color, texture or appearance of the object, so as to determine if the decor of the object suits the space and to allow the user to select a satisfactory color, texture or appearance.

Although the present invention has been described in relation to particular embodiments thereof, many other variations and modifications and other uses will become apparent to those skilled in the art. Therefore, the present invention should be limited not by the specific disclosure herein, but only by the appended claims.

What is claimed is:

1. A method for determining the fit of an object in a space comprising:
obtaining digital data defining the space;
inputting the digital data defining the space into a computer system;
inputting at least one dimension defining the space;
obtaining digitized data defining an object to be fitted in the space;
placing the digitized data defining the object in the digitized space; and
determining if the object fits in the space.

2. The method of claim 1, further comprising displaying the object in the space on a display device.

3. The method of claim 1, further comprising moving the object in the space if the fit is unsatisfactory and displaying the moved object in the space.

4. The method of claim 1, wherein the digital data defining the space is obtained from a digital camera.

5. The method of claim 1, wherein the digital data defining the space is obtained from a film camera and subsequently by scanning the film camera image into digital data and inputting it into the computer system.

6. The method of claim 1, wherein the step of obtaining digital data defining the space further comprises using edge location software to determine the outlines of the space and of existing objects, if any, in the space.

7. The method of claim 1, further comprising determining the overall dimensions of the space and of existing objects, if any, in the space based on the at least one dimension and the digital data defining the space.

8. The method of claim 1, further comprising moving existing objects in the space around the object to determine a satisfactory fit of the object in the space.

9. The method of claim 3, further comprising moving existing objects in the space around the object to determine a satisfactory fit of the object in the space.

10. The method of claim 1, wherein the object comprises a piece of furniture or electrical/electronic appliance and the space comprises at least a portion of a room.

11. The method of claim 1, further comprising visualizing the color, texture or appearance of the object in the space on the display device.

12. The method of claim 1, further comprising allowing a user to change the color, texture or appearance of the object on the display device and to select a desired color, texture or appearance for the object.

13. A system for determining the fit of an object in a space comprising:
a computer system for receiving:
digital data defining the space;
at least one dimension defining the space;
digitized data defining an object to be fitted in the space;
the computer system placing the digitized data defining the object in the digitized space and determining if the object fits in the space; and
further comprising a display for displaying the object in the space.

14. The system of claim 13, further wherein the computer system moves the object in the space at a user's command if the fit is unsatisfactory and displays the moved object in the space.

15. The system of claim 13, wherein the digital data defining the space is obtained from a digital camera.

16. The system of claim 13, wherein the digital data defining the space is obtained from a film camera and by subsequently scanning the film camera image into digital data and inputting it into the computer system.

17. The system of claim 13, wherein the computer system comprises edge location software to determine the outlines of the space and existing objects, if any, in the space.

18. The system of claim 13, further wherein the computer system moves existing objects in the space around the object to determine a satisfactory fit of the object in the space.

19. The system of claim 14, wherein the computer system moves existing objects in the space around the object to determine a satisfactory fit of the object in the space.

20. The system of claim 13, wherein the computer system determines the overall dimensions of the space and of existing objects, if any, in the space based on the at least one dimension and the digital data defining the space.

21. The system of claim 13, wherein the object comprises a piece of furniture or electrical/electronic appliance and the space comprises at least a portion of a room.

22. The system of claim 13, wherein the computer system further displays the color, texture or appearance of the object in the space on the displace device.

23. The system of claim 22, further wherein the computer system allows a user to change the color, texture or appearance of the object on the display device and to select a desired color, texture or appearance for the object.

24. Computer software operable on a computer system for determining the fit of an object in a space comprising:
computer code for receiving as inputs:
digital data defining the space;
at least one dimension defining the space; and
digitized data defining an object to be fitted in the space;
the computer code instructing the computer system to place the digitized data defining the object in the digitized space and determine if the object fits in the space; and
further wherein the computer code provides data to a display device for displaying the object in the space.

25. The computer software of claim 24, further wherein the computer system operating the computer software moves the object in the space at a user's command if the fit is unsatisfactory and displays the moved object in the space.

26. The computer software of claim 24, wherein the digital data defining the space is obtained from a digital camera.

27. The computer software of claim 24, wherein the digital data defining the space is obtained from a film camera and by subsequently scanning the film camera image into digital data and inputting it into the computer system.

28. The computer software of claim 24, further comprising edge location software to determine the outlines of the space and of existing objects, if any, in the space.

29. The computer software of claim 24, further wherein the computer system operating the computer software moves existing objects in the space around the object to determine a satisfactory fit of the object in the space.

30. The computer software of claim 25, wherein the computer system operating the computer software moves existing objects in the space around the object to determine a satisfactory fit of the object in the space.

31. The computer software of claim 24, wherein the computer system operating the computer software determines the overall dimensions of the space and of existing objects, if any, in the space based on the at least one dimension and the digital data defining the space.

32. The computer software of claim 24, wherein the object comprises a piece of furniture or electrical/electronic appliance and the space comprises at least a portion of a room.

33. The computer software of claim 24, comprising a digital storage medium comprising a magnetic disc, compact disc or DVD.

34. The computer software of claim 24, wherein the computer system further displays the color, texture or appearance of the object in the space on the display device.

35. The computer software of claim 34, further wherein the computer system allows a user to change the color, texture or appearance of the object on the display device and to select a desired color, texture or appearance for the object.
